(19) United States
(12) Patent Application Publication
(10) Pub. No.: US 2004/0000766 A1
(43) Pub. Date: Jan. 1, 2004

(54) Movable storage container

(76) Inventor: Erik T. Ekstein, New York, NY (US)

Correspondence Address: COUDERT BROTHERS LLP, Third Floor, 600 Beach Street, San Francisco, CA, 94109, US

(21) Appl. No.: 10/185,389

(22) Filed: Jun. 28, 2002

(51) Int. Cl. B62B 3/00

(52) U.S. Cl. 280/47.34; 280/79.2

(57) ABSTRACT

The invention provides a movable storage container configured to fit through standard residential doors. In a preferred embodiment, a movable storage container having features of the invention is about 6 feet high, between about 3 foot and about 4 foot wide, and between about 26 inches and about 28 inches deep, and is preferably cedar-lined. A movable storage container having features of the invention may have external attachment features configured to engage with ropes, straps, cables, or other tractor elements, and may include an internal bar configured to engage clothes hangers, preferably by having perforations sized to receive a hanger hook so as to prevent their lateral movement along the bar. The external attachment features are preferably disposed on the base of the container. The invention further provides systems including a movable storage container and a tractor element, and optionally including instructions.

### CROSS-REFERENCE TO RELATED APPLICATIONS

This application is related to co-pending application filed on Jun. 28, 2002, entitled “Method and System for Storing Items Using a Portable Closet” by Erik Ekstein, U.S. application Ser. No. ______, the disclosure of which is hereby incorporated by reference in its entirety.

### FIELD OF THE INVENTION

The present invention relates generally to the field of containers. More particularly, it relates to the field of movable storage containers.

### BACKGROUND OF THE INVENTION

Useful items often require storage. For example, work items that are only used on an occasional basis may be stored until needed, and personal items such as seasonal clothing may be stored during the months when such clothing is not suitable or needed. Stored items are often placed within storage containers for protection from the elements, to maintain segregation from other items stored nearby, for security, and for other reasons.

Storage at a home or place of business is often not practical, particularly in high density urban environments where space is at a premium. In such environments, particularly where long-term storage is desired, a storage container will typically be situated at a location distant from the site at which the items are initially located. This requires, at the very least, the loading of a storage container at the storage site, or the transportation of a filled storage container to a storage location.

However, loading storage containers at a storage site requires transporting the items to be stored to the container. Where items to be stored are numerous, large, or heavy, transport of items from an initial site to a site of storage may be difficult. However, loading a storage container away form the storage location may also be problematic, since a filled storage container is often heavy and unwieldy, making it difficult to transport a filled container from an initial site to a site of storage. In addition, once items are stored at a remote site in a storage container, there may be a significant disadvantage in retrieving the items, since the filled storage container may be heavy, large, or unwieldy, as discussed above.

Accordingly, there is need in the art for storage containers and storage methods that alleviate the problems of transporting items to be stored between an initial site and a storage site, and which provides convenient retrieval of one or more items from storage.

### SUMMARY OF THE INVENTION

A movable storage container having features of the invention may comprise a sturdy enclosure with rollers and an identifier configured to pass through a standard residential doorway, and having an internal bar for holding clothes hangers attached to the top portion of the enclosure. The enclosure has a top, a base with corners, side walls, and at least one door, the inner wall surfaces defining an interior storage space. The container preferably has a rectangular parallelepiped shape. Rollers, such as wheels, casters or bearings, are attached to the base, preferably near the corners. Each container has an identifier that can be read from outside the container, such as a bar code, an alphanumeric serial number, a radiofrequency tag, or other identifier. The identifiers allow each container to be differentiated from other containers and facilitates the retrieval of the correct container from a storage location, which may contain numerous movable storage containers. may include an internal bar configured to engage clothes hangers. The internal bar is preferably perforated or otherwise configured to engage and retain clothes hangers so as to prevent their lateral movement during transport of the container, and is preferably attached to the top of the container. The containers also preferably include a lining, such as a cedar lining, suitable for preserving and protecting clothes and other fragile items stored within the enclosure.

A movable storage container having features of the invention is configured for repeated transport through standard doorways, within passenger elevators, and for transport by hand, truck, fork-lift, and other means of transport. Thus, a movable storage container having features of the invention preferably has exterior dimensions of no more than about 6 feet high, no more than about 4 feet wide, and no more than about 28 inches deep, preferably being between about 3 feet wide and 4 feet wide, and between about 26 inches deep and about 28 inches deep, with a total height of less than about 6½ feet including rollers.

A movable storage container having features of the invention may include external eyescrews or eyebolts, hooks, pegs, cleats or other engagement elements configured to catch and hold a rope, cord, cable, strap, belt, pole, or other tractor device for pulling, pushing, or otherwise maneuvering the container along its rollers. The external engagement elements are preferably disposed on the base of the container.

The invention also provides a system for storing and retrieving items from a remote location and for delivering said items to and from a location accessible through a standard doorway. Such systems include a movable storage container that includes a sturdy enclosure configured to pass through a standard residential doorway, an internal bar configured to engage a clothes hanger, rollers attached to the base, and an externally perceptible identifier; and a tractor element such as a rope, cord, strap, belt or pole for maneuvering the container. A tractor element may be configured to engage an engagement element. A system may also include a set of instructions.

Movable storage containers having features of the invention provide improved storage by enabling convenient transport of the container between the loading site and the storage site. The invention provides individuals having items at one location with a convenient way to store the items at a separate location. A movable storage container having features of the invention is readily moved into and out of apartment and office buildings, through standard doorways and via passenger elevators, allowing one to easily pack items for storage, and to retrieve items from storage, at a home or place of business. For example, a residential user may place winter clothes into a movable storage container having features of the invention for storage at a storage facility until they are needed; in this way, the movable storage container serves as a movable closet. Similarly, business users may place seasonal items or merchandise into a movable storage container for storage at a remote storage location until the items are again needed or suitable to offer for sale. By bringing the storage location to the site from which items are to be removed, the present invention makes storage more efficient and simpler.

These and other advantages of the invention will become more apparent from the following detailed description of the invention and the accompanying exemplary drawings.

### BRIEF DESCRIPTION OF THE DRAWINGS

FIG. 1 is a perspective view of a system including movable storage container having features of the invention, a rope with hooks, and instructions for its use.

FIG. 2 is a perspective view of a movable storage container having features of the invention with two doors in a closed configuration.

FIG. 3 is a front elevation view of a movable storage container having features of the invention with two doors in an opened configuration.

FIG. 4 is a side elevation view of movable storage container having features of the invention.

FIG. 5 is a perspective view showing the internal surface of a top of a movable storage container having features of the invention and an attached a perforated hanger bar having features of the invention.

FIG. 6 is a perspective view of a base of a movable storage container having features of the invention.

### DETAILED DESCRIPTION OF THE INVENTION

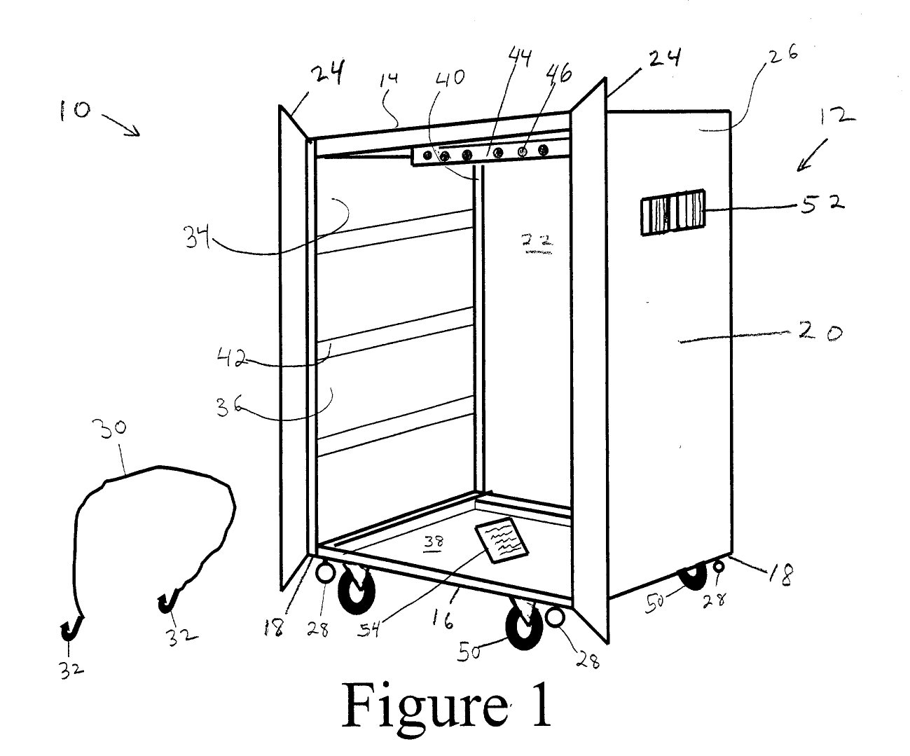

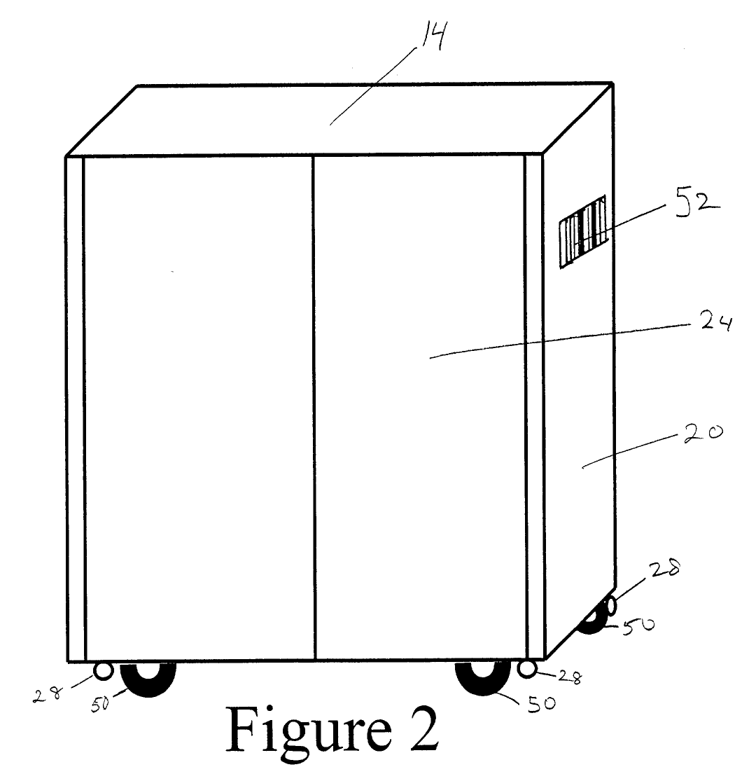

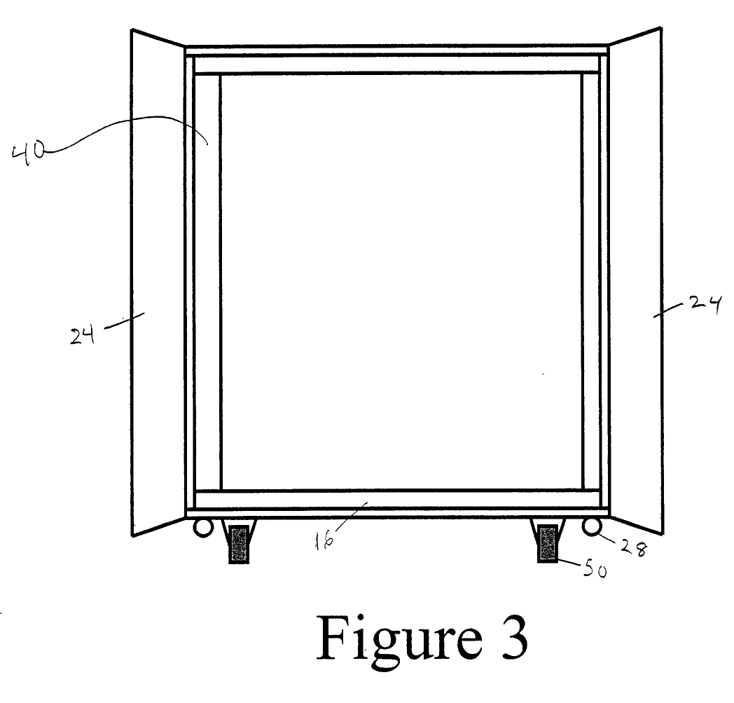

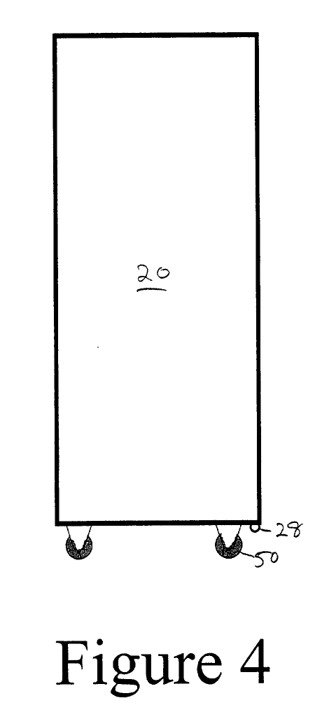

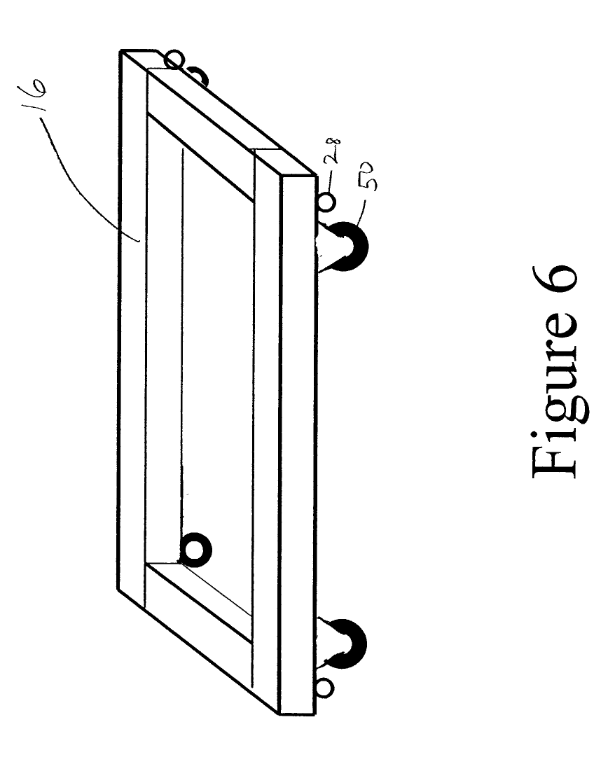

Reference is made to FIGS. 1-6 which illustrate a movable storage system 10 including a movable storage container 12 embodying features of the invention. The system 10 generally includes container 12 which may be a sturdy enclosure comprising a top 14, a base 16 with corners 18, side walls 20, a back wall 22, and at least one door 24. Movable storage containers 12 preferably have two doors 24. In preferred embodiments, a movable storage container 12 is a rectangular parallelepiped, with a rectangular base 16 having four corners 18, and flat top 14, side walls 20, and back 22.

The exterior of container 12 is configured to pass through a standard residential doorway. The exterior dimensions of a container 12 having features of the invention include dimensions of no more than about 6 feet high, no more than about 4 feet wide, and no more than about 28 inches deep. In preferred embodiments, a container 12 has exterior dimensions of between about 3 feet wide and about 4 feet wide, and of between about 26 inches deep and about 28 inches deep, most preferably having exterior dimensions of about 6 feet high, about 4 feet wide, and about 28 inches deep. Also in preferred embodiments, the container 12 has no projections (e.g., no handles, grips, or brackets) projecting outside of these dimensions which could obstruct passage of the movable storage container 12. Thus, in preferred embodiments, the exterior surface 26 of a container 12 is generally flat.

Instead of handles placed around the exterior 26, which would interfere with movement in close quarters, containers 12 having features of the invention have engagement elements (such as eyescrews 28 shown in the Figures) attached to the base 16 to aid in maneuvering the containers when necessary. A tractor element, such as a rope 30 having hooks 32 attached to its ends, can be used to engage with engagement elements such as eyescrews 28 and to pull or guide a container 12 on its path to be loaded with items at a loading site or on its path to a storage site. Attachment of an engagement element such as an eyescrew 28 to base 16, preferably near a corner 18, facilitates the maneuvering of a movable storage container 12 without interfering with its passage through a doorway or other narrow space. This insures that the container 12 may be easily maneuvered through tight doorways, hallways, and elevators, as may be encountered in apartment and office buildings.

An engagement element may be any element configured to engage, or be engaged by, a tractor element. For example, an engagement element may be an eyebolt, an eyescrew, or other element having an eyelet or loop; may be a hook, a ring, or a cleat; may be a peg, a stud, a latch, a grommet, or a slot; may be a fastening material such as Velcro®; and may be combinations of these or other elements. Any implement or tool suitable for pulling, pushing, or otherwise moving a container 12, including a rope 30 with hooks 32, may serve as a tractor element to maneuver a container 12. Thus, a tractor element may be a rope, a cable, a strap, a cord, a lanyard, and other flexible elongated materials, with or without hooks or other specialized features; a tractor element may include a pulley; and may be a bar, a beam, and other less-flexible or rigid implements.

The interior storage space is generally defined by the inner wall surfaces 34 of the container 12. The side walls 20 and back 22 have inner surfaces 34 which may have a lining 36, such as a cedar lining. For example, a cedar lining may be stapled or otherwise attached to an inner wall surface 34 to provide a suitable storage environment for clothes, furs, and delicate and other items. Other inner surfaces, such as a the inner surface of the top 14, the inner surfaces of doors 24, or the floor 38 on the base 16, may also optionally have a lining 36, which may be a cedar lining or other lining (e.g., the floor 38 may be covered with a waterproof lining). In preferred embodiments, a ¼ inch cedar panel is stapled onto one or more interior walls 34 to form a cedar lining within a container 12.

The container 12 preferably has a frame 40, which is most preferably an internal frame as illustrated in the Figures, including side braces 42 which not only add strength and rigidity to the container 12, but may also serve to support shelves (not shown). Shelves that are fixed to side braces 42 (e.g., by screws) serve to increase the strength of the container as well as to provide storage options. It is desirable to have a strong container 12. It is preferred that a container 12 be sturdy so that a container 12 may be repeatedly transported to and from a storage location, where it may be, for example, maneuvered by hand, by forklift, or by other means, to be stored until needed. Methods of storing and retrieving movable storage containers 12 and systems 10 are disclosed in the related application entitled “Method and System for Storing Items Using a Portable Closet” by Erik Ekstein.

A container 12 is preferably internally configurable, having multiple configurations with or without an inner lining 36, or an inner lining 36 of differing materials, and optionally having differing numbers and placement of shelves. A container 12 need not have any shelves (as shown in the Figures), and optionally may have one or more internal shelves. Preferably, a shelf fits onto and is supported by the frame 40. For example, a shelf may be made from ¾ inch plywood, and slid onto 2 foot by 3 foot supports 42 in frame 40 within side walls 20. Shelves may rest on side braces 42, or may be held in place by screws, nails, glue, or other attachment means. Alternatively, slots to receive and hold shelves may be formed in inner surfaces 34 of side walls 20.

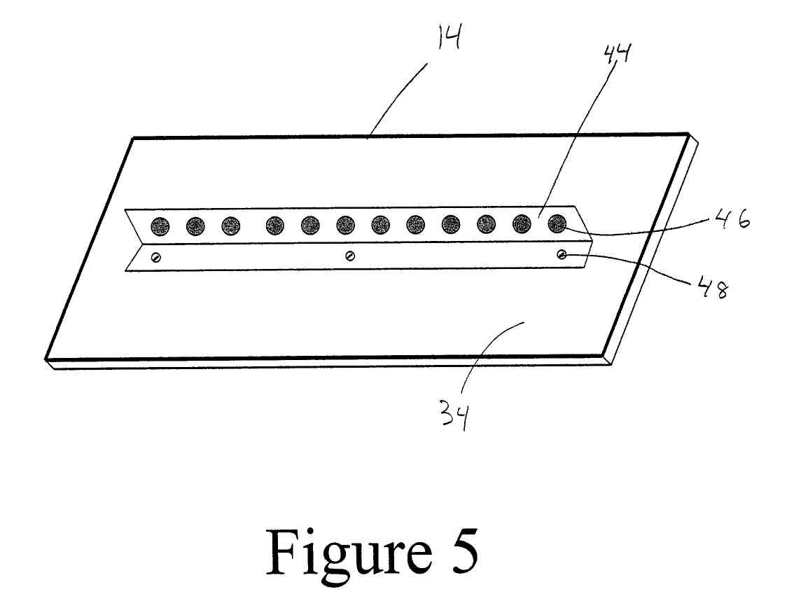

Movable storage containers 12 having features of the invention may include a hanger bar 44 attached to the inner surface 34 of the top 14 within the interior storage space. A hanger bar 44 is configured to engage a clothes hanger, having a perforation 46, or preferably multiple perforations 46 through which the hook of a hanger may be passed. A hanger bar 44 with perforations 46 is configured to securely retain, and to prevent the lateral movement of, clothes hangers. Such secure retention, and prevention of movement, acts to insure that hung clothing stored within a movable storage container 12 remains in place on the hanger bar 44 during transport of the container 12. Perforations 46 may be holes (as shown in the figures), slots, or other passages in a material having sufficient strength to support a clothes hanger and any clothing or other load carried by the clothes hanger. A hanger bar may also optionally be screwed into middle shelf to provide a second tier of hanger support. Preferably, a hanger bar 44 is made of metal, such as steel, iron, aluminum, or other metal, although plastics, composites and other materials are also suitable. In preferred embodiments, the hanger bar is made from metal angle bar with holes drilled through the bar to provide perforations 46 and also to provide screw holes for screws 48 used to attach the hanger bar 44 to the top 14, as illustrated in FIG. 5. Perforations 46 are preferably greater than about ⅛ inch wide (greater than about ⅛ inch in diameter where the perforations 46 are round holes). In a most preferred embodiment, a hanger bar is made from a 46 inch by 1.5 inch by 1.5 inch iron angle bar, and has multiple 1 inch-diameter holes to accept clothes hanger hooks.

A movable storage container 12 has a plurality of rollers 50 attached to the base 16. Rollers 50 may be wheels (as shown in the figures), casters, bearings, or any other rolling elements that allow the container 12 to roll across a surface. For example, rollers 50 may be no-scuff wheels configured to minimize possible damage to floors and flooring materials. Preferably, rollers 50 allow a container 12 to be steered or readily directed as the container 12 is moved from one place to another. More preferably, rollers 50 can swivel around a vertical axis as well as roll around an axle or around a horizontal axis, or are otherwise steerable. Rollers 50 may optionally include brakes or stops to prevent movement when a container 12 is parked in a temporary or permanent storage location. A movable storage container 12 preferably has four wheels attached to a four-cornered base 16, with a wheel attached to each one of four corners 18 of the base 16. The rollers 50 preferably add only a few inches to the height of the movable container, so that the total height of a movable storage container 12 on rollers 50 is less than about 6½ feet, preferably less than about 6⅓ feet.

A movable storage container 12 may have an externally perceptible identifier such as a bar code label 52. Movable storage containers 12 may be stored in rows in an ordered array on a floor surface, stacked in columns as well as in rows, held in identified locations on a wall or other surface, or may be stored in any other suitable manner. A bar code label 52, or other externally perceptible identifier, allows the differentiation of a particular movable storage container 12 from other movable storage containers 12, and thus facilitates the proper identification and retrieval of a particular movable storage container 12 from a storage location.

An externally perceptible identifier may be directly perceptible by eye, ear, touch or other sense. Alternatively, an externally perceptible identifier may be perceptible by an instrument or tool, and may be a passive or an active tag. For example, either a passive or an active radiofrequency tag may be an externally perceptible identifier. A passive radiofrequency tag responds to a signal from a signal device so as to identify a particular movable storage container 12. An active tag produces a signal identifying the container 12 and indicating its location in the absence of an external signal from a signal device. Such identification devices and systems are commercially available (e.g., (TI-RFiD products, Texas Instruments, Dallas, Tex., USA). Other passive and active identification devices that use signals other than radiofrequency signals (e.g., infra red, ultrasound, or other signals) are also indicated by the term “radiofrequency tag” and are also suitable for use as externally perceptible identifiers for movable storage containers 12 having features of the invention.

Thus, an externally perceptible identifier may be a label, such as bar code label 52, an alphanumeric sign written, stenciled, or attached to an exterior surface 26 of a container 12. A bar-code label 52 or other such identifier is preferably mounted on an exterior surface 26 in a visible location to aid the identification and retrieval of the container 12 from a storage location. Alternatively, an externally perceptible identifier may be a tag, including both passive and active tags, located within or on the outside of a movable storage container 12 that is perceptible from a location outside the container 12 without opening a door 24 of the container 12. Such a tag may be a radiofrequency tag, a magnetic label or strip, or other magnetic identifier.

Thus, a most preferred embodiment of a movable storage container 12 having features of the invention includes a sturdy rectangular parallelepiped enclosure having exterior dimensions of about 6 feet high, about 4 feet wide, and about 28 inches deep; two doors 24; a hanger bar 44 attached to the inner wall surface 28 of the top 14, having multiple round holes about 1 inch in diameter; four wheels attached to the base 16 near the comers 18; a bar-code label 52; at least two eyescrews 28 or other engagement elements; and optionally including a cedar inner lining 36.

Movable storage containers 12 may be utilized as part of a system 10 for storing items in, and retrieving items, from a storage location. Such containers 12 may be any configuration of movable storage container 12, including the most preferred configuration. A system 10 for storing and retrieving items from a remote location and for delivering said items to and from a location accessible through a standard doorway, includes a movable storage container 12 and a tractor element such as a rope 30. Preferably, the movable storage container 12 of a system 10 has an engagement element such as an eyescrew 28, and the tractor element is preferably configured to engage the engagement element. In further embodiments of a system 10, the movable storage container 12 may include a lining 36, such as a cedar lining, and the tractor element may include specialized features such as a hooks 32 on the ends of a rope 30.

A further embodiment of a system 10 for storing and retrieving items from a remote location and for delivering said items to and from a location accessible through a standard doorway may include a set of instructions 54. Thus, a system 10 may include a movable storage container 12, and a set of instructions 54 for its use, or a movable storage container 12, a tractor element (such as a rope 30), and a set of instructions 54. A set of instructions 54 may include instructions on how best to pack a movable storage container 12, how to request and schedule delivery or retrieval of a movable storage container 12 from a storage site, how to prepare items for storage, and other information.

For example, a set of instructions 54 may provide instructions for use of a movable storage container 12 provided by a service provider. In such a situation, for example, a customer may receive a movable storage container 12 from a service provider in which the customer may store items that are not presently needed at the customer's location. A service provider may deliver a movable storage container 12 to a customer site from a storage location, where the movable storage container 12 may be packed with one or more items. The service provider may then retrieve the partially or completely full movable storage container 12 and transport the movable storage container 12 to a storage facility. The movable storage container 12 may remain in the storage facility until a stored item is desired or until further items are to be stored. Upon request, the movable storage container 12 may be removed from storage and transported to the customer site, where an item or items may be retrieved from the movable storage container 12, items loaded into the movable storage container 12, or the contents of the movable storage container 12 may otherwise be modified. The movable storage container 12 may then be again transported from the customer site to a storage facility. The process of return to the customer, pick-up, and re-storage may be repeated, so that a movable storage container 12 serves as a virtual closet to the customer.

A set of instructions 54 may be printed on the movable storage container 12, or may be affixed to it; or may be printed on a single sheet of paper, on multiple sheets of paper, or printed in a pamphlet. Alternatively, a set of instructions 54 may include a videotape or compact disk (CD) providing instructions in sound and images when played on a videoplayer or CD player; or may be combinations printed and other forms of instructions.

Those skilled in the art will recognize that various modifications may be made to the specific embodiments illustrated above, and are considered to be within the scope of the claims that follow.

What is claimed is:

1. A movable storage container, comprising:
a sturdy enclosure comprising a top, a base with corners, side walls, and at least one door, said enclosure having inner wall surfaces defining an interior storage space and having exterior walls having surfaces configured to pass through a standard residential doorway;
a bar configured to engage a clothes hanger;
a plurality of rollers attached to said exterior surface of said base; and
an externally perceptible identifier.

2. The movable storage container of claim 1, wherein said sturdy enclosure comprises exterior dimensions of no more than about 6 feet high, no more than about 4 feet wide, and no more than about 28 inches deep.

3. The movable storage container of claim 2, wherein said sturdy enclosure comprises exterior dimensions of between about 3 feet wide and about 4 feet wide, and of between about 26 inches deep and about 28 inches deep.

4. The movable container of claim 1, wherein an inner wall surface comprises a lining attached to said exterior wall.

5. The movable container of claim 1, wherein an inner wall surface comprises a cedar surface.

6. The movable container of claim 4, wherein an inner wall surface comprises a cedar lining.

7. The movable storage container of claim 1, wherein said rollers are selected from the group consisting of wheels, casters, and bearings.

8. The movable storage container of claim 7, wherein said plurality of rollers comprises four wheels, said base comprises four corners, and wherein a wheel is attached to said base near each of said four corners.

9. The movable storage container of claim 1, wherein said bar configured to engage a clothes hanger comprises a plurality of perforations.

10. The movable storage container of claim 9, wherein said perforations comprise holes having diameters of greater than about ⅛ inch.

11. The movable storage container of claim 1, wherein said bar is attached to said top on said inner wall surface within said interior storage space.

12. The movable storage container of claim 1, wherein said externally perceptible identifier is selected from the group consisting of bar codes, alphanumeric symbols, magnetic labels, radiofrequency tags, passive labels, active labels, and combinations thereof.

13. The movable storage container of claim 12, wherein said externally perceptible identifier comprises a bar code label.

14. The movable storage container of claim 1, further comprising two doors.

15. The movable storage container of claim 1, further comprising an engagement element disposed on said outside surface of said base.

16. The movable storage container of claim 15, wherein said engagement element is selected from the group consisting of eyebolts, eyescrews, eyelets, loops, hooks, rings, cleats, pegs, studs, latches, grommets, slots, Velcro® and combinations thereof.

17. The movable storage container of claim 16, wherein said engagement feature comprises at least two eyescrews, and wherein each of said eyescrews is attached to said base near a corner of said base.

18. A system for storing and retrieving items from a remote location and for delivering said items to and from a location accessible through a standard doorway, comprising:
a movable storage container comprising a sturdy enclosure having a top, a base with corners, side walls, and at least one door, said enclosure having inner wall surfaces defining an interior storage space and having exterior surfaces configured to pass through a standard residential doorway; a bar configured to engage a clothes hanger; a plurality of rollers attached to said base; an engagement element; and an externally perceptible identifier; and
a tractor element configured to engage said engagement element.

19. The system of claim 18, wherein said tractor element is selected from the group consisting of a rope; a cord; a strap; a belt; a bar; a pipe; a beam; and combinations thereof.

20 The system of claim 18, wherein said bar is attached to said top on said inner wall surface within said interior storage space.

21. The system of claim 18, wherein said inner wall surface comprises a cedar surface.

22. The system of claim 18, wherein said externally perceptible identifier comprises a bar code label.

23. The system of claim 18, further comprising a set of instructions.

24. The system of claim 23, wherein said set of instructions is selected from the group consisting of instructions printed on said container; instructions affixed to said container; instructions printed on a single sheet of paper; instructions printed on multiple sheets of paper; instructions printed in a pamphlet; a videotape providing instructions in sound and images when said videotape is played on a videoplayer; a compact disk (CD) providing instructions in sound and images when said CD is played on a CD playback device; and combinations thereof.

25. A movable storage container, comprising:
a sturdy enclosure with an inner wall surface and an outside surface, said surfaces comprising a top, a base with four corners, side walls, and a door defining an interior storage space and having exterior dimensions of about 6′ high, about 4′ wide, and about 28″ deep;
a bar attached to said top inner wall surface within said interior storage space and having a plurality of holes with diameters greater than about ⅛″;
four wheels attached to said outside surface of said base, one wheel at each corner;
a bar-code identifier; and
at least two eyelets disposed on said outside surface of said base.

26. The movable storage container of claim 25, wherein said inner wall surface comprises a cedar surface.

27. A hanger bar configured to accept clothes hanger hooks, comprising a metal angle bar having a first and a second flat portion, each of said portions having a width of about 1.5 inches, said flat portions being connected and forming two substantially perpendicular flat surfaces, said first flat portion having multiple holes having diameters of about 1 inch, said second flat portion being configured to be attached to a surface.

28. The hanger bar of claim 27, comprising a length of about 46 inches.
